(19) United States
(12) Patent Application Publication
(10) Pub. No.: US 2008/0002733 A1
(43) Pub. Date: Jan. 3, 2008

(54) Method and apparatus for scheduling transmissions in multiple access wireless networks

(76) Inventor: Ilan Sutskover, Hadera (IL)

Correspondence Address: INTEL CORPORATION;c/o INTELLEVATE, LLC, P.O. BOX 52050, MINNEAPOLIS, MN, 55402, US

(21) Appl. No.: 11/479,714

(22) Filed: Jun. 30, 2006

(51) Int. Cl. H04J 3/16

(52) U.S. Cl. 370/436

(57) ABSTRACT

Methods and apparatuses for schedule transmissions between a base station and multiple user stations includes dividing a transmit time interval (TTI), in some embodiments referred to as a “frame,” into a plurality of portions or subchannel sets. The scheduler may optimize the assignment of users to spectrum within each subchannel set, per-user power and/or beamforming coefficients for each subchannel set only once over a limited number of contiguous TTIs. A next subchannel set may then be optimized at the next TTI. However, optimization of the modulation and coding scheme (MCS) for each subchannel set may be performed more often, for example, every TTI. Additional embodiments and variations are also disclosed.

### BACKGROUND OF THE INVENTION

It is becoming more important to be able to provide telecommunication services to subscribers which are relatively inexpensive as compared to cable and other land line technologies. Further, the increased use of mobile applications has resulted in much focus on developing wireless systems capable of delivering large amounts of data at high speed.

Development of more efficient and higher bandwidth wireless networks has become increasingly important and addressing issues of how to maximize efficiencies of such networks is an ongoing issue. One such issue relates to efficient scheduling of transmissions between a base station and multiple user stations in a multiple access wireless network such as a network using orthogonal frequency division multiple access (OFDMA) protocols.

### BRIEF DESCRIPTION OF THE DRAWING

Aspects, features and advantages of embodiments of the present invention will become apparent from the following description of the invention in reference to the appended drawing in which like numerals denote like elements and in which:

FIG. 1 is block diagram of an example wireless network according to various embodiments;

FIG. 2 is a flow diagram showing an exemplary method base station scheduling according to various embodiments;

FIG. 3 is a diagram showing an example scheduling pattern resulting from a scheduling method similar to that described with reference to FIG. 2; and

FIG. 4 is a block diagram showing an example wireless apparatus configured for scheduling multiple users in an OFDMA wireless network.

### DETAILED DESCRIPTION OF THE INVENTION

While the following detailed description may describe example embodiments of the present invention in relation to broadband wireless metropolitan area networks (WMANs), the invention is not limited thereto and can be applied to other types of wireless networks where similar advantages may be obtained. Such networks specifically include, if applicable, wireless local area networks (WLANs), wireless personal area networks (WPANs) and/or wireless wide area networks (WWANs) such a cellular networks and the like. Further, while specific embodiments may be described in reference to wireless networks utilizing multi-user Orthogonal Frequency Division Multiplexing (OFDM) otherwise referred to as Orthogonal Frequency Division Multiple Access (OFDMA), the embodiments of present invention are not limited thereto and, for example, can be implemented using other air interfaces where suitably applicable.

The following inventive embodiments may be used in a variety of applications including transmitters and receivers of a radio system, although the present invention is not limited in this respect. Radio systems specifically included within the scope of the present invention include, but are not limited to, network interface cards (NICs), network adaptors, fixed or mobile access points, mesh stations, base stations, hybrid coordinators (HCs), gateways, bridges, hubs, routers or other network peripherals. Further, the radio systems within the scope of the invention may include cellular radiotelephone systems, satellite systems, personal communication systems (PCS), two-way radio systems and two-way pagers as well as computing devices including such radio systems such as personal computers (PCs) and related peripherals, personal digital assistants (PDAs), personal computing accessories, hand-held communication devices and all existing and future arising systems which may be related in nature and to which the principles of the inventive embodiments could be suitably applied.

Current wireless and cellular systems employ mostly channel unaware transmission methods. That is, a transmission typically depends on a quality of service (QoS) and available queue at the base station as well as on a signal to interference-plus-noise ratio (SINR), channel quality indicator (CQI) or other sampling system at the mobile side as reported to the base station using some feedback mechanism. The SINR/CQI value may be averaged over the entire spectrum and usually is also averaged over time by some type of sliding window operation.

A scheduler is the element of a network access station such as a base station or access point (AP) (hereinafter generically referred to as “base station”) that may generally be responsible for assignment of bandwidth (e.g., subcarrier/subchannel allocation for multiple subscribers in OFDMA frames), selecting the modulation and coding scheme (MCS) and/or specifying transmit power. A channel unaware scheduler, as described above, may make decisions based on a limited feedback in the form of SINR or CQI. By way of contrast, a channel aware scheduler has instantaneous channel knowledge, for example, in the form of a (estimated) transfer function, which allows the scheduler to smartly assign subchannels to various users for example.

While a base station may be aware of the channel between itself and its associated subscriber stations (for example by use of a channel sounding mechanism as specified in the Institute of Electrical and Electronics Engineers (IEEE) 802.16e standard for Mobile Wireless Metropolitan Area Networks; IEEE Std 802.16e-2005), the base station will typically be unaware of the channel(s) between adjacent base stations and that same subscriber. This fact dramatically reduces the base station's ability to properly assign an optimized modulation and coding scheme for each subscriber station, which may result in significant system-level performance degradation. This situation may even worsen when multiple antennas are used at the base stations for beamforming where the variance of the interference experienced by many subscribers is large, resulting in even more severe performance degradation.

In various embodiments of the present invention, scheduling methods and apparatuses are disclosed that facilitate flexible bandwidth assignment yet reduces the vulnerability of improper or inefficient MCS assignment. To this end, the inventive embodiments rely on a trade-off between instantaneous spectrum assignment and instantaneous MCS assignment to any subscriber. To better understand this trade-off, it is noted that when the spectrum assignment (e.g., subchannel assignment) is fixed, as well as the beamforming coefficients and the per-user power, then MCS assignment is rather robust and may simply rely on a proper SINR feedback. However, because channels vary with time it becomes desirable to adjust beamforming coefficients to optimize multi-antenna transmissions to account for the varying channel conditions. Further, in order to optimize multi-user diversity, spectrum reassignment and power reassignment may be beneficial.

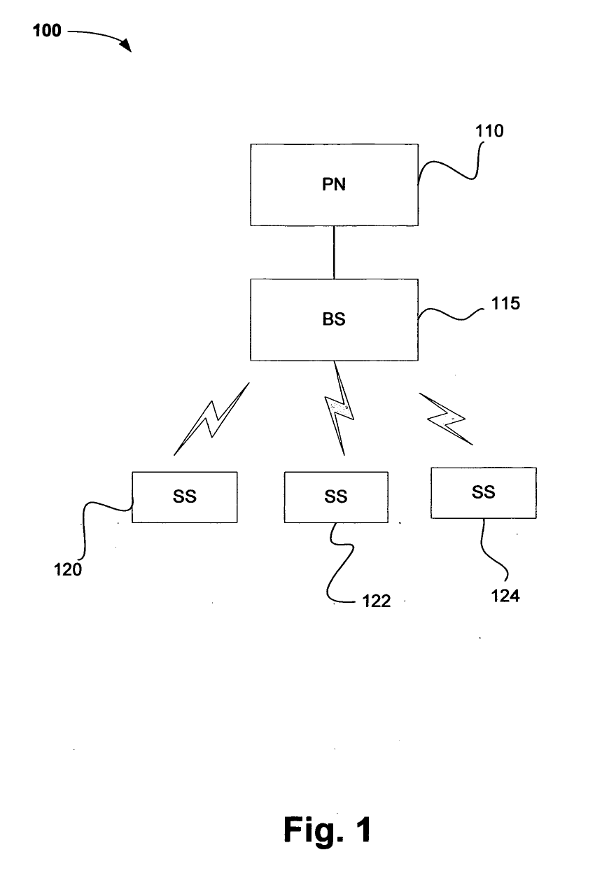

Turning to FIG. 1, a wireless communication network 100 according to various inventive embodiments may be any wireless system capable of facilitating wireless access between a provider network (PN) 110 and one or more subscriber stations 120-124 including mobile or fixed subscribers. For example in one embodiment, network 100 may be a high throughput wireless communication network such as those contemplated by various IEEE 802.16 standards for fixed and/or mobile broadband wireless access (BWA), a 3^{rd} Generation Partnership Project (3GPP) Long Term Evolution (LTE) mobile phone network or other type of high bandwidth WMAN, WLAN or WWAN.

In the IEEE 802.16 standards (sometimes referred to as WiMAX, an acronym that stands for Worldwide Interoperability for Microwave Access), two principle communicating wireless network nodes are defined including the Base Station (BS) (e.g., base station 115) and the Subscriber Station (SS) (e.g., subscriber stations 120, 122, 124). However, these terms are used in a generic manner throughout this specification and their denotation in this respect is in no way intended to limit the inventive embodiments to any particular type of network.

In the example configuration of FIG. 1, base station 115 is a managing entity which controls the wireless communications between subscriber stations 120-124 and provider network 110 and/or potentially between the subscriber stations themselves. Subscriber stations 120-124 in turn, may facilitate various service connections of other devices (not shown) to network 110 via a private or public local area network (LAN), although the embodiments are not limited in this respect.

In one implementation base station 115 may send data to subscriber stations 120-124 in downlink (DL) and receives data from stations 120-124 in uplink (UL) in a sequence of transmission time intervals (TTIs). A TTI in some network configurations such as IEEE 802.16 standards may be referred to as an air frame or a frame. In other network configurations, TTIs may be referred to as a packet. In one example embodiment, uplink and downlink communications are maintained by sending frames at constant, but configurable intervals (e.g. every 5 ms). OFDMA, also referred to as Multiuser-OFDM, is being considered as a modulation and multiple access method for next generation wireless networks. OFDMA is an extension of Orthogonal Frequency Division Multiplexing (OFDM), OFDM currently being the modulation of choice for many high speed data access systems such as IEEE 802.11a/g wireless LAN (WiFi) and IEEE 802.16a/d wireless broadband access systems (WiMAX).

OFDMA allows simultaneous transmission to multiple users. Since the probability that all users experience a deep fade in a particular subcarrier is very low, optimization of subcarrier or subchannel assignment can assure that subcarriers are assigned to the users that see good channel gains on them.

In OFDMA, each single radio frame or TTI may therefore consist of a plurality of active (i.e., available for carrying data) subcarriers which may be partitioned into subsets of adjacent or non-adjacent subcarriers called subchannels where each subchannel may be available for assignment to a different user station. In time division duplex (TDD) mode, each frame may actually consist of an uplink subframe and a downlink subframe but subchannel assignment within these subframes is similar for all intended purposes. Uplink assignments may be independent of the downlink assignment. Moreover, (i) different users may be served on the UL and DL at the same frame, different numbers of subchannel sets may be used for the UL subframe and the DL subframe, and/or different periodicity lengths may be used for the uplink and for the downlink, In this manner, data transfer between a base station and multiple subscriber stations may be accomplished at every TTI. In scalable OFDMA (sOFDMA), the number of subcarriers available for partitioning may be varied depending on the number users present and/or the number subchannels needed. The various embodiments however are not limited to any particular type or implementation of OFDMA or even use of OFDMA as the scheduling algorithms discussed herein may be implemented using any multiple access modulation scheme where suitably applicable.

Data sent within a radio frame may consist of a number of bursts where each burst is a continuous portion of data that may be sent over the allocated subchannels using a certain modulation scheme (e.g., binary phase shift keying (BPSK) or some level of quaternary phase shift keying (QPSK) or quaternary amplitude modulation (QAM). If desired, some form of Forward Error Correction (FEC) coding such as convolutional coding (CC) or convolutional turbo coding (CTC) may be used as well. In the inventive embodiments, these are collectively referred to as a modulation and coding scheme (MCS).

In various inventive embodiments, a base station scheduler, which may be a portion of a medium access control (MAC) subconvergence layer, may be responsible for multi-user subchannel assignment, per-user power selection, determining optimal beamforming coefficients and/or selection of MCS.

Beamforming is a signal processing technique used with arrays (e.g., at least two or more antennas) of transmitters or receivers that may be used to control the directionality of, or sensitivity to, a radiation pattern. It is worthy to recognize that, beamforming may be a mathematical averaging of signals which may impact the physical directionality of a beam but not necessarily. In OFDM or OFDMA systems, each subcarrier may undergo a different beamforming process, yielding an output signal (in the time domain) whose “directionality” is very difficult to define. When transmitting a signal, beamforming can increase the gain in the direction the signal is to be sent by creating beams and nulls in an antenna array radiation pattern. Beamforming is a form of spatial filtering which is well known and selection/use of beamforming coefficients depends on the specific conditions of a wireless network. For example, the number of transducers, range of transmission, transmit power for each transducer and/or general algorithm for beamforming are extremely dependent on the network environment. Since beamforming techniques are known in the art and are significantly network dependent, specific implementations on the selection/use of beamforming coefficients are not described here but rather left up to the discretion of the network designer.

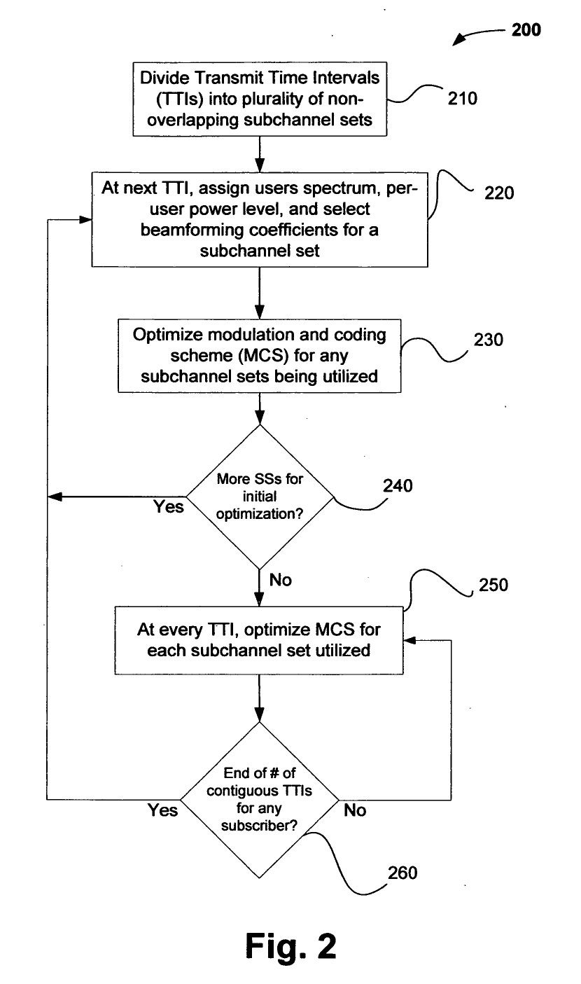

Turning to FIG. 2, a method 200 for scheduling transmissions by a may generally include dividing 210 a transmit time interval (TTI) (or “frame” in WiMAX terminology) having a number of subchannels into a number of non-overlapping subchannel sets. In IEEE 802.16e, for example, the number of subchannels may be thirty-two in certain cases and if the number of channel subsets desired is four, then the result is four sets of eight subchannels in each TTI. In other implementations, the number of subchannels available might be twenty-four. It should be recognized that the number of subchannels available for assignment will depend on the type of network or specific implementation available and in fact may even be varied using sOFDM; thus the inventive embodiments are not limited to any specific values.

At each TTI, scheduling optimization 220 may be performed for subchannel sets per TTI. In one embodiment, scheduling optimization 220 may be performed over one, and only one, of the subchannel sets per TTI. In other embodiments, optimization 220 may be performed for more than one subchannel set (e.g., two) at each TTI. In various embodiments, scheduling optimization 220 may include one or more of (i) assigning available spectrum (e.g., subchannels) of a subchannel set to one or more subscribers, (ii) assigning a per-user power level for the subscriber(s), and/or (iii) determining optimal beamforming coefficients for transmission to the subscriber(s). Additionally, optimization 230 of a modulation and coding scheme (MCS) for over-the-air communication of the subchannel set may be performed although it is not required. This stage of scheduling optimization 220, 230 is referred to herein as “initial optimization.” With the exception of the MCS, thereafter the same parameters for spectrum assignment, power-level, and beamforming coefficients will be used for communication with the subscriber station(s) for a limited number of contiguous TTIs. If 240 there are additional subscribers that require initial optimization or the same subscriber needs additional bandwidth, at the next TTI, this process may be repeated 220, 230. It should be noted that same user may be assigned more than one subchannel sets over various TTIs (the first set at time t and the second set at time t+1 for example) thus a user is not confined to assignment of spectrum within only a single subchannel set. However, once being assigned a subchannel set, one or more transmission parameters (e.g., spectrum, power and/or beamforming coefficients) associated with a particular assignment, are preferably not changed until the limited number of contiguous TTIs following the subchannel set assignment has elapsed.

Accordingly, in various embodiments, power, spectrum and/or beamforming coefficients may be assigned 220 only at an initial optimization stage for each subscriber station and remain unchanged for a certain number of contiguous TTIs or frames. In contrast, the MCS for each subscriber's assigned subchannel set may be optimized 230, 250 more frequently, for example at every transmit time interval or at every other time interval. At the end 260 of a certain number of contiguous TTIs from each subscriber station's initial optimization, the power level, subchannel set assignment and/or beamforming coefficients may be re-assigned 220 to accommodate flexibility with the time varying channel characteristics.

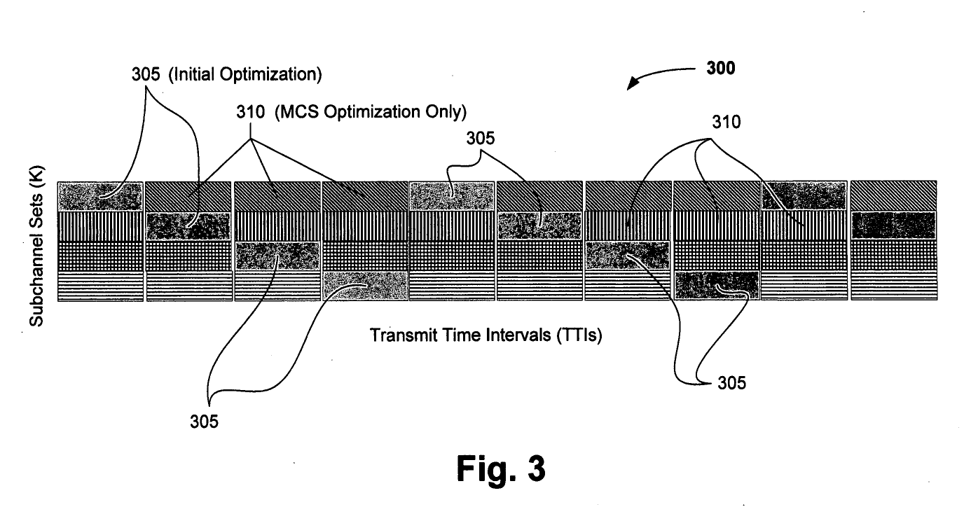

Turning to FIG. 3, an illustrative pattern 300 of scheduling optimization according to one example embodiment is shown. The four rows in the illustrative pattern correspond four non-overlapping subchannel sets (K) into which an entire available spectrum of 32 subchannels is divided (e.g. 210; FIG. 2). The columns of pattern 300 represent contiguous TTIs or frames. Each gray shaded box in the pattern denotes a TTI in which an initial optimization 305 is performed for one of the subchannel sets (K). The boxes in each row between initial optimizations 305 for each subchannel subset (K) are TTIs 310 in which only the MCS optimization (e.g., 230; 250) for the subchannel subset (K) is performed (i.e., where user selection, power assignment, spectrum assignment and beamforming assignment are all fixed according to the most recent initial optimization 305 in the same row).

In this example, in which K=4 is used, each subscriber is served such that the subchannel(s) associated with it (as well as the power, and beamforming coefficients) are selected or re-assigned once every four contiguous transmit time intervals. In a WiMAX configuration, K=4 corresponds to 20 ms between each initial optimization 305 for a particular subchannel set whereas MCS optimization is performed every 5 ms.

The foregoing scheduling algorithm allows relatively large flexibility for spectrum assignment (1/K of the flexibility of the entire bandwidth), which facilitates reasonable utilization of multi-user diversity as well as easy support for QoS constraints. Note that at each TTI, new subscriber selection/assignment for a subchannel set may be performed. On the other hand, on the K−1 TTIs 310 that follow an initial optimization stage, the transmission parameters associated with initial optimization are not changed. Accordingly, if adjacent base stations in the wireless network are coordinated with respect to these optimizations, then at least over the K−1 TTIs associated with the MCS-only optimization state, the MCS assignment may be robust and accurate. However, even if base stations are not synchronized a certain level of gain may be achieved by virtue of a high rate of MCS assignment (at the base station of interest) and more accurate beamforming coefficients calculation (e.g., at adjacent cells), in the cases where beamforming is to be used.

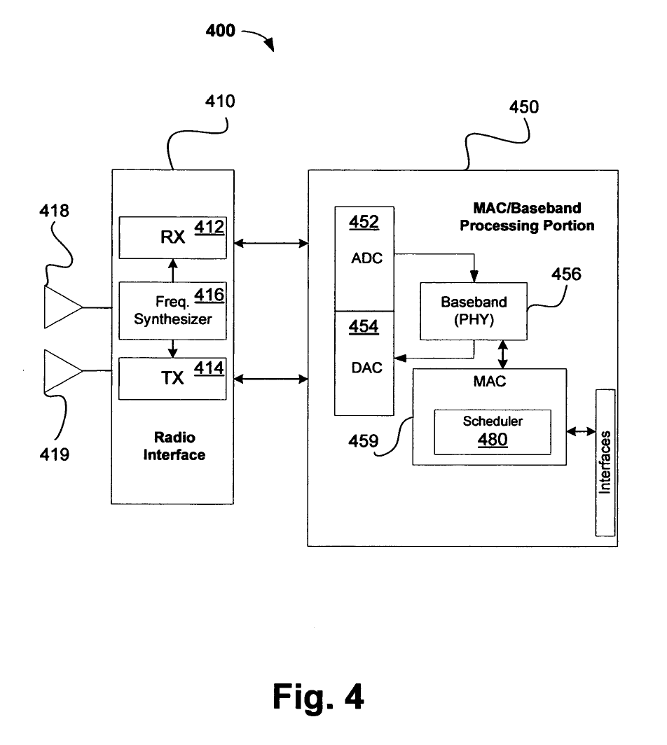

Referring to FIG. 4, an apparatus 400 for use in a wireless network may include a processing circuit 450 including logic (e.g., circuitry, processor and software, or combination thereof) to schedule traffic for multiple subscribers as described in one or more of the processes above. In certain non-limiting embodiments, apparatus 400 may generally include a radio frequency (RF) interface 410 and a medium access controller (MAC)/baseband processor portion 450.

In one example embodiment, RF interface 410 may be any component or combination of components adapted to send and receive multi-carrier modulated signals (e.g., OFDMA) although the inventive embodiments are not limited to any specific over-the-air (OTA) interface or modulation scheme. RF interface 410 may include, for example, a receiver 412, a transmitter 414 and a frequency synthesizer 416. Interface 410 may also include bias controls, a crystal oscillator and/or one or more antennas 418, 419 if desired. Furthermore, RF interface 410 may alternatively or additionally use external voltage-controlled oscillators (VCOs), surface acoustic wave filters, intermediate frequency (IF) filters and/or radio frequency (RF) filters as desired. Various RF interface designs and their operation are known in the art and an expansive description thereof is therefore omitted.

Processing portion 450 may communicate with RF interface 410 to process receive/transmit signals and may include, by way of example only, an analog-to-digital converter 452 for down converting received signals, a digital-to-analog converter 454 for up converting signals for transmission, and if desired, a baseband processor 456 for physical (PHY) link layer processing of respective receive/transmit signals. Processing portion 450 may also include or be comprised of a processing circuit 459 for medium access control (MAC)/data link layer processing.

In certain embodiments of the present invention, MAC processing circuit 459 may include a scheduler 480, in combination with additional circuitry such as a buffer memory (not shown) and baseband circuit 456, may function to divide TTIs into subchannel sets, assign users to subchannel sets, assign per-user power levels and calculate beamforming coefficients as in the embodiments previously described. Alternatively or in addition, baseband processing circuit 456 may perform these processes independent of MAC processing circuit 459. MAC and PHY processing may also be integrated into a single circuit if desired.

Apparatus 400 may be, for example, a base station, an access point, a hybrid coordinator, a wireless router or NIC and/or network adaptor for computing devices. Accordingly, the previously described functions and/or specific configurations of apparatus 400 could be included or omitted as suitably desired. In some embodiments apparatus 400 may be configured to be compatible with protocols and frequencies associated one or more of the IEEE 802.16 standards for broadband wireless networks, although the embodiments are not limited in this respect.

Embodiments of apparatus 400 may be implemented using single input single output (SISO) architectures. However, as shown in FIG. 4, certain preferred implementations may include multiple antennas (e.g., 418, 419) for transmission and/or reception using spatial division multiple access (SDMA) and/or multiple input multiple output (MIMO) communication techniques. Further, embodiments of the invention may utilize multi-carrier code division multiplexing (MC-CDMA) multi-carrier direct sequence code division multiplexing (MC-DS-CDMA) for OTA link access or any other existing or future arising modulation or multiplexing scheme compatible with the features of the inventive embodiments.

The components and features of station 400 may be implemented using any combination of discrete circuitry, application specific integrated circuits (ASICs), logic gates and/or single chip architectures. Further, the features of apparatus 400 may be implemented using microcontrollers, programmable logic arrays and/or microprocessors or any combination of the foregoing where suitably appropriate. It is noted that hardware, firmware and/or software elements may be collectively or individually referred to as “logic” or “circuit”.

It should be appreciated that the example apparatus 400 shown in the block diagram of FIG. 4 represents only one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments of the present invention.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method for communicating in a wireless network, the method comprising:
optimizing at least one of spectrum assignment, power assignment or beamforming coefficients for downlink communication with a first subscriber station, wherein optimizing the spectrum assignment, power assignment and/or beamforming coefficients is only performed over a first transmit time interval (TTI) of a limited number of contiguous TTIs and remains the same for a remainder of the limited number of contiguous TTIs; and
optimizing a modulation and coding scheme (MCS) for the downlink communication with the first subscriber station at at least two TTIs of the limited number of contiguous TTIs.

2. The method of claim 1 further comprising:
optimizing at least one of spectrum assignment, power assignment or beamforming coefficients for downlink communication with the first subscriber station or a second subscriber station, wherein optimizing the spectrum assignment, power assignment and/or beamforming coefficients is performed only at a TTI other than the first TTI and remains the same for a remainder of a same limited number of contiguous frames.

3. The method of claim 1 wherein each TTI comprises an orthogonal frequency division multiple access (OFDMA) frame.

4. The method of claim 3 wherein spectrum assignment comprises assigning the first subscriber station to subchannel of one or more subchannel sets of the OFDMA frame.

5. The method of claim 1 further comprising re-optimizing the at least one of spectrum assignment, power assignment or beamforming coefficients at a first TTI of a new limited set of contiguous TTIs for downlink communication with the first subscriber station.

6. The method of claim 1 wherein the method is also performed for uplink communication with the first subscriber station.

7. An apparatus for wireless communication, the apparatus comprising:
a scheduler to select at least one of spectrum assignment, power assignment or beamforming coefficients for downlink communications with a first subscriber station only once for a subchannel set during a limited number of contiguous transmit time intervals (TTIs) and to optimize a modulation and coding scheme (MCS) for the downlink communications with the first subscriber station using the subchannel set at more than one TTI in the limited number of contiguous TTIs.

8. The apparatus of claim 7 wherein the scheduler is operative to reassign at least one of spectrum, power or beamforming coefficients for the subchannel set only at a first TTI of a new set of contiguous TTIs.

9. The apparatus of claim 7 further comprising a radio frequency (RF) interface communicatively coupled to the scheduler, the RF interface comprising a plurality of antennas to facilitate spatial diversity multiple access (SDMA) communications.

10. The apparatus of claim 7 wherein each TTI comprises an orthogonal frequency division multiple access (OFDMA) frame.

11. The apparatus of claim 10 wherein the scheduler is operative to divide each OFDMA frame into a plurality of subchannel sets each to be used for downlink transmission to subscriber stations.

12. The apparatus of claim 10 wherein the scheduler is operative to perform scheduling optimization over only one of the plurality subchannel sets at each OFDMA frame.

13. The apparatus of claim 7 wherein the apparatus comprises a base station.

14. An article of manufacture comprising a tangible medium storing machine readable instructions, the machine readable instructions, when executed by a processing device, result in:
dividing a transmit time interval (TTI) into a plurality of subchannel sets to be used for communication with one or more user stations;
for each subchannel set, assigning one or more users spectrum, per-user power and/or beamforming coefficients, wherein assignment for each of the plurality of subchannel sets is performed at a different TTI and only once for each subchannel set over a limited number of contiguous TTIs; and
selecting a perceived optimal modulation and coding scheme (MCS) for each subchannel set at more than one TTI of the limited number of contiguous TTIs.

15. The article of claim 14 wherein the machine readable instructions, when executed by the processing device, further result in:
re-designating for a subchannel set, at least one of the user spectrum per-user power or beamforming coefficients for communication after the limited number of contiguous TTIs has occurred.

16. The article of claim 14 wherein the TTI comprises an orthogonal frequency division multiple access (OFDMA) frame.

17. The article of claim 14 wherein the apparatus comprises at least a portion of, or a memory coupled to, a base station medium access control (MAC) circuit.

18. A system for wireless communications, the system comprising:
a processing circuit to schedule downlink communications with a plurality of user stations; and
a radio interface circuit coupled to the processing circuit, the radio interface including at least two antennas to transmit modulated signals in the form of electromagnetic waves;
wherein the processing circuit is configured to divide a transmit time interval (TTI) into a plurality of subchannel sets and to schedule one or more user stations including at least one of a spectrum assignment, per-user power or beamforming coefficients for communications with the one or more user stations, wherein scheduling is performed for only a single subchannel set per TTI and remains unchanged for the single subchannel set over a limited number of contiguous TTIs; and wherein the processing circuit is further configured to select an updated modulation and coding scheme (MCS) for the single subchannel set at more than one TTI of the limited number of contiguous TTIs.

19. The system of claim 18 wherein each transmit time interval (TTI) comprises an orthogonal frequency division multiple access (OFDMA) frame.

20. The system of claim 18 wherein the system comprises a broadband wireless network base station.

21. The system of claim 18 wherein the processing circuit is configured to designate the at least one of the spectrum assignment, per-user power or beamforming coefficients, at least in part, based on a channel transfer function estimating a channel between a base station and the one or more user stations.
